(19) United States
(12) Patent Application Publication
(10) Pub. No.: US 2014/0353187 A1
(43) Pub. Date: Dec. 4, 2014

(54) CUSTOMIZABLE ATTACHABLE ARTICLE WITH INTEGRATED BINOCULAR POCKET AND KIT

(71) Applicant: Russell Murrey, Valrico, FL (US)

(72) Inventor: Russell Murrey, Valrico, FL (US)

(21) Appl. No.: 13/904,320

(22) Filed: May 29, 2013

(51) Int. Cl. A45F 5/02; G02B 23/18; A45C 11/08

(52) U.S. Cl. CPC A45F 5/02; A45C 11/08; G02B 23/18
USPC 206/316.3; 493/264

(57) ABSTRACT

A customizable attachable article with integrated binocular pocket includes a main body having an adhesive material and removable covering layer disposed along the back surface, and a pocket disposed along the front surface. The main body and pocket being constructed from a durable and printer friendly material. The article also includes a display screen for displaying digital event indicia. A kit also includes a customizable attachable article with integrated binocular pocket and a pair of folding binoculars.

### TECHNICAL FIELD

The present invention relates generally to the field of ornamentation and event merchandise, and more particularly to an adhesive backed customizable article for clothing that has an integrated binocular pocket and collapsible binocular kit.

### BACKGROUND

The statements in this section merely provide background information related to the present disclosure and may not constitute prior art.

Each year, millions of individuals pack venues across the globe to view events ranging from sports to music festivals. While in attendance, these individuals are presented with an exhausting choice of event merchandise such as stickers, T-shirts, banners, and other such keepsakes. Additionally, for those fans who are not seated close to the event stage, binoculars, radios and other such items are often needed to fully enjoy the event.

However, many people attending such events find carrying binoculars inconvenient, or simply forget to bring binoculars with them. Because of concerns about stock loss, hygiene, and administrative convenience, selling binoculars is preferable over renting binoculars at such events, even though these items are likely to be used only once.

As the above noted merchandise items are event specific, designs which incorporate details such as the performer/team names, color schemes, dates and the like must be finalized weeks in advance to ensure that all event merchandise items can be manufactured and shipped to the venue in time for the event. Additionally, great care must be taken by merchants to accurately anticipate crowd levels, projected sales, and other such factors to ensure they are not left with unsold merchandise after the event has concluded.

Although there are known products such as iron-on patches, for example, which can include event details and be created on-demand during the event, these items are not generally popular, as they cannot be customized to suit the end user, and cannot be secured to the users existing clothing without permanently altering the same.

Accordingly, it would be beneficial to provide a customizable and attachable article with an integrated binocular pocket, and a kit which includes binoculars that can be produced on-demand during an event. It would be further beneficial if the article can be customized to include both event details and customer-desired details, and can be worn by users without causing permanent damage to their existing clothing.

### SUMMARY OF THE INVENTION

The present invention is directed to a customizable attachable article with integrated binocular pocket and kit.

One embodiment of the present invention can include an attachable article having a main body that includes an adhesive material and removable covering layer disposed along the back surface, and a pocket disposed along the front surface. The main body and pocket being constructed from a durable material and including a size which can be utilized with a conventional printer. The main body being attachable to an article of clothing and the pocket includes a size that is suitable for receiving a pair of folding binoculars.

Another embodiment of the present invention can include one or more removable sections of the main body. At least one of the sections can have a shape and dimension suitable for adherence onto the front panel of a pair of folding binoculars. Additionally, the article can further include a display screen removably secured onto the main body and capable of displaying digital event indicia.

Yet another embodiment of the present invention can include a kit having the article and folding binoculars described above.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal view of a customizable attachable article with integrated binocular pocket that is useful for understanding the inventive concepts disclosed herein.

FIG. 2 is a perspective view of a folding binocular device which can be utilized with the customizable attachable article with integrated binocular pocket of FIG. 1.

FIG. 3 is a front view of the customizable attachable article with integrated binocular pocket, in accordance with another embodiment of the invention.

FIG. 4 is a perspective view of a kit which includes the customizable attachable article with integrated binocular pocket and folding binocular device, in accordance with one embodiment of the invention.

FIGS. 5-7 illustrate one embodiment of the kit in operation, in accordance with one embodiment of the invention

FIG. 8 is a front view of the customizable attachable article with integrated binocular pocket, in accordance with an alternate embodiment of the invention.

FIG. 9 is a schematic block diagram of a controller for the customizable attachable article with integrated binocular pocket, in accordance with the alternate embodiment of claim 8.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

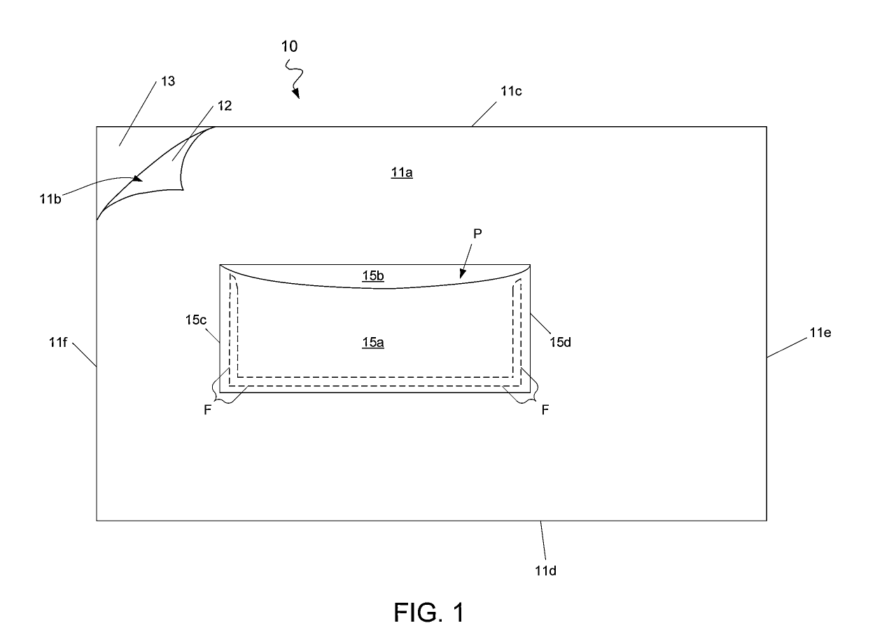

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As described throughout this document, the term “event indicia” can include, without limitation, any type of decorative elements such as colors, markings, words, shapes, symbols, logos, designs, types of materials, lights, patterns, images, lithographs and photographs, for example. To this end, the event indicia can be tailored to a specific event having pre-approved themes, or can be customized to suit the particular interests of an end user, to include personal items such as the users name, dates and personal messages, for example.

Additionally, the term “venue” can include any location such as an arena, stadium, store, mall, home or office where the article may be shipped, stored and/or sold to consumers.

FIG. 1 illustrates one embodiment of a customizable attachable article with integrated binocular pocket 10 that is useful for understanding the inventive concepts disclosed herein. As shown, the article can include a main body 11 having a peel and stick backing and at least one pocket for storing event items such as binoculars.

The main body 11, can be custom printed with event indicia and can be removably attached to an article of the users clothing. To this end, the main body can include a top surface 11a, a back surface 11b, a top edge 11c, a bottom edge 11d and a pair of opposing side edges 11e and 11f. As the main body is designed to be adhered to an article of clothing in a peel-and-stick manner, an adhesive material 12 and removable covering layer 13 can also be provided.

The pocket 15 can include, essentially, an envelope having a front side member 15a and a back side member 15b that are bound together by a bottom edge 15c and a pair of opposing side edges 15d and 15e to form a pocket P having an open top edge for receiving any number of items, such as the binoculars 20 described below. To this end, the side and bottom edges 15c-15e can be folded F back upon themselves any number of times in order to increase or decrease the size of the pocket in order to receive and store the binoculars 20 when the article is being worn by a user.

In the preferred embodiment, the main body can be constructed from a single sheet of 8.5×11 inch synthetic soft polyester paper which is known to include waterproof and static resistant features. Additionally, as synthetic polyester paper is, essentially, a hybrid between traditional paper and cloth, it is well known to be extremely durable, and to maintain printed images and the like (e.g., event indicia) for extremely long periods of time without fading or bleeding. Additionally, as is known to those of skill in the art, synthetic paper is compatible with commercially available laser and ink jet printers without requiring modification of any kind. Additionally, the pocket 15 can be secured to the main body in accordance with known construction methodologies, such as adhesive tape and glue, for example, or can be formed as an integral part of the main body at a time of initial construction in accordance with known manufacturing techniques. Of course, any number of other types and sizes of material can also be utilized.

In either instance, the pocket 15 can preferably be constructed from a substantially identical material as the main body 11 and configured to rest in a flat orientation when no secondary items are stored within the pocket itself. As will be described below, by providing a flat envelope that is secured onto the main body, the entire article 10 can be fed into a conventional printer in order to receive any number of event indicia.

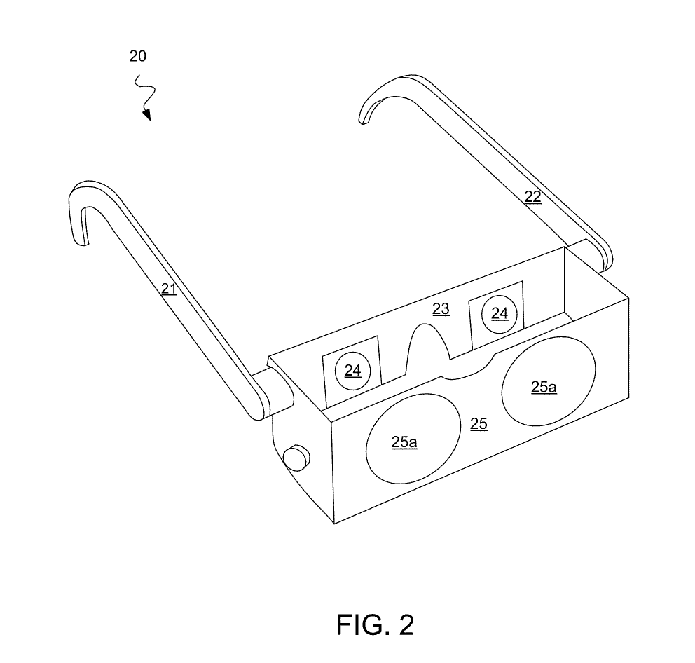

FIG. 2 illustrates one suitable embodiment of folding binoculars 20 which can be provided with the device 10 to form an attachable customizable binocular kit. As shown, the binoculars 20 can resemble a traditional pair of eye glasses having a pair of folding side members 21 and 22 that are connected to a fixed rear frame member 23 housing a pair of spaced eyepiece lenses 24. A front panel 25 having a pair of spaced objective lenses 25a is slidably secured to the rear frame to allow users to focus the lenses. Folding binoculars such as that described above are known in the art and include U.S. Pat. No. 4,637,696, the contents of which are incorporated herein by reference. Of course, the invention is not to be limited to these binoculars, as any number of other folding binoculars can also be provided without limitation.

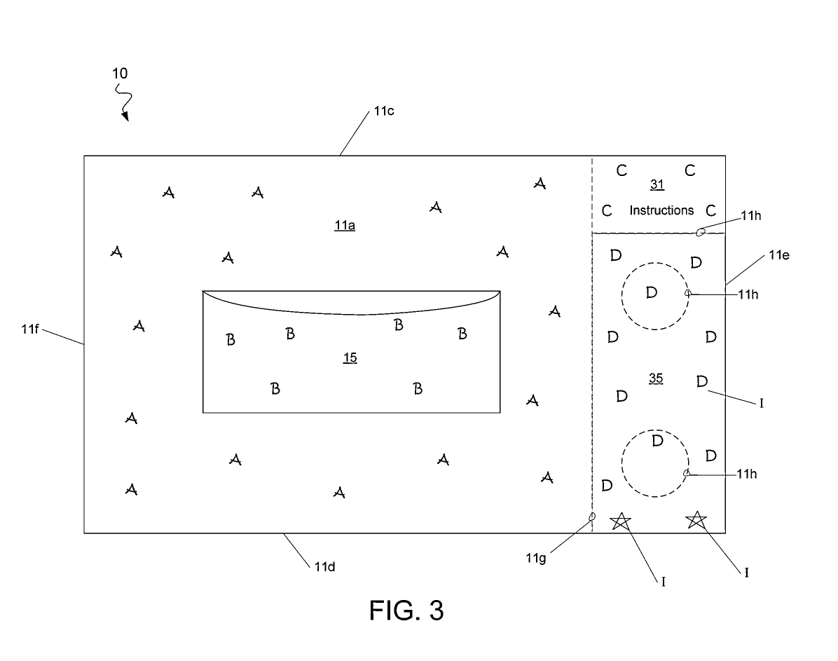

FIG. 3 illustrates an alternate embodiment of the customizable attachable article with integrated binocular pocket 10 wherein the main body 11 further includes a pair of removable sections 31 and 35 which can be created via a first scored line 11g extending from the top edge 11c to the bottom edge 11d, and a second scored line 11h extending transversely from the first scored line 11g to the side edge 11f. In the preferred embodiment, removable section 35 can include a shape and dimension that is complementary to the shape of the front panel 25 of the binoculars described above, and can further include scored lines 11h, which when removed from section 35 form a pair of circular apertures 35a having a shape and position that is complementary to the lenses 25a of the binoculars.

As described above, the entire article can be imprinted with any number of event indicia I, A, B, C and D. As such, the event indicia imprinted onto sections 31 and 35 can be different than the event indicium that is printed on the remainder of the main body and the pocket. To this end, in the preferred embodiment, section 31 can include instructions for utilizing the kit, or can include any number of secondary information such as a coupon, for example.

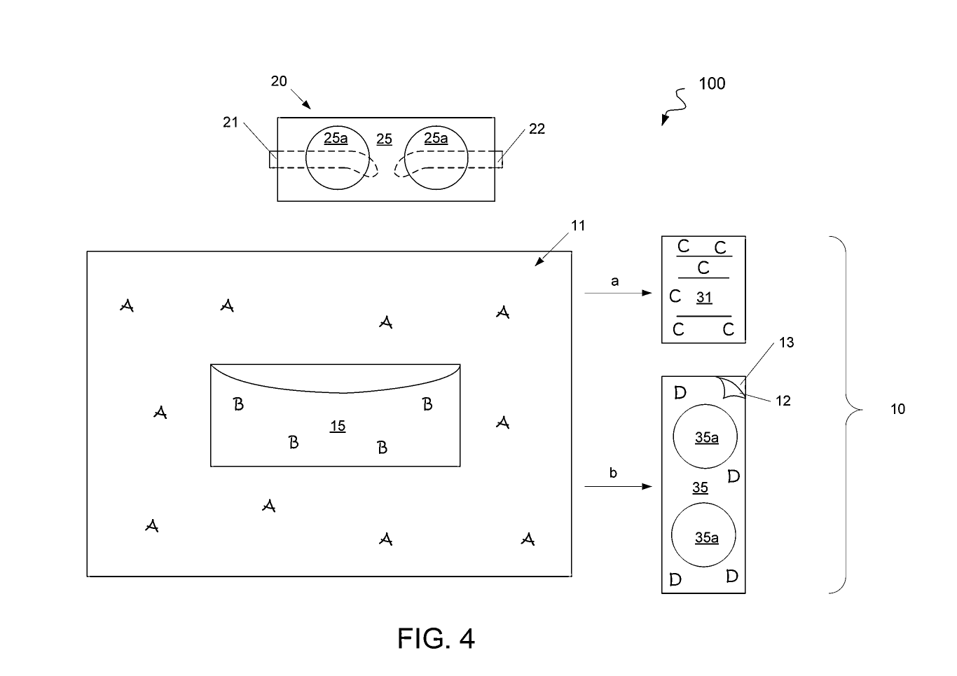

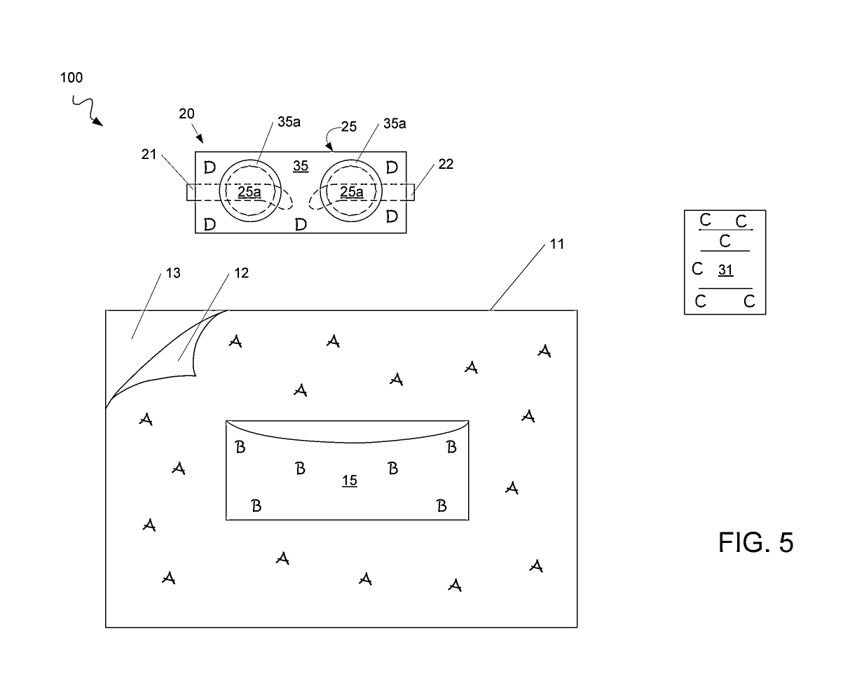

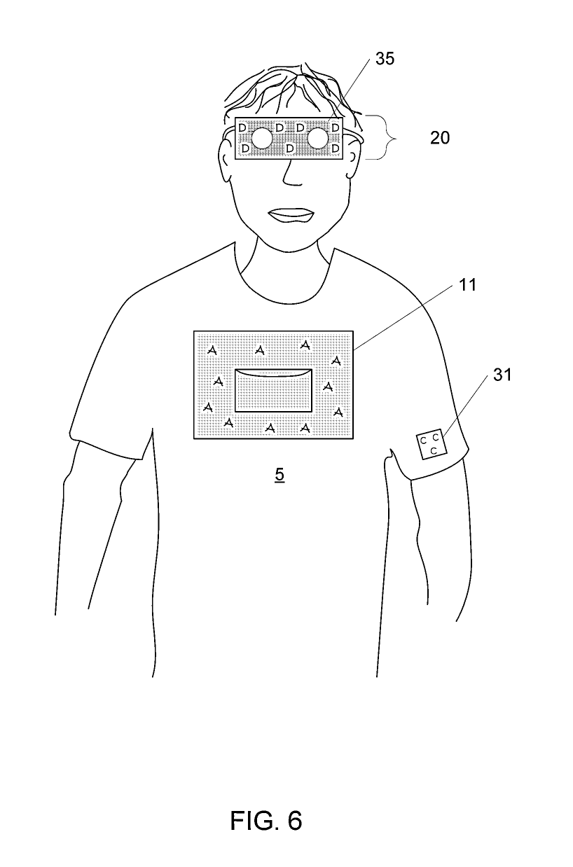

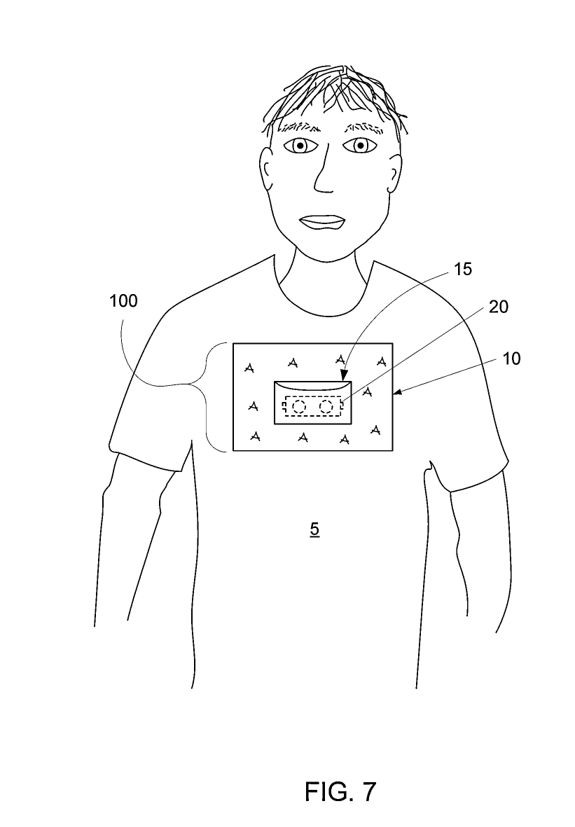

FIGS. 4-7 pictorially illustrate one embodiment of a kit 100 that includes the article 10 and binoculars 20 described above, in operation and a method of utilizing the same.

As shown, the originally blank article 10 can first be imprinted with any number of desirable event indicia A-D, as described above. Next, the removable sections 31 and 35 can be separated from the main body 11, as shown by arrows a and b, at which time the circular apertures 35a can be created by removing the material encompassed by scored lines 11h. Once the sections have been separated, the covering layer 13 can be removed from the back surface of the section 35, and section 35 can then be adhered to the front panel of the binoculars 25.

Finally, the covering layer 15 which remains on the back surface of the body 11 can be removed, and the main body 11 can be adhered to an article of clothing of the user 5. When so positioned, the user can experience the benefits of wearing event indicia without damaging their clothing, and simultaneously be provided with a convenient storage pouch for the binoculars, which also sport the event indicia in a hands free manner.

Although described above as including a single pocket 15, and two removable sections 31 and 35, this is for illustrative purposes only, as those of skill in the art will recognize that any number of pockets and/or removable sections can be incorporated into the design of the article 10. These pockets and sections can be located anywhere along the main body and can be used to store any number of items which may also be sold with the kit. These items can include, for example, walkie-talkies, radios, headphones, and other such goods commonly sold or rented at events. To this end, with each additional pocket, the article can also include one or more additional removable sections having a shape and dimension for being adhered thereto in a manner similar to that described above. Moreover, although described above as being printed at the venue, this is but one preferred method of distribution, as the articles can also be pre-printed at the location of manufacture and shipped to the venue.

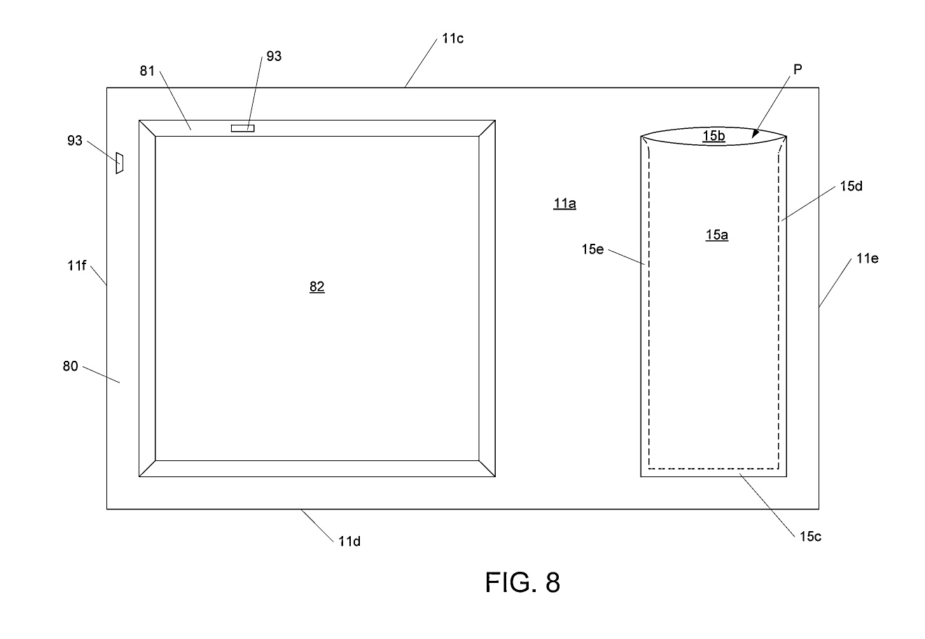

FIG. 8 illustrates yet another alternate embodiment of the customizable article with integrated binocular pocket 10 that further includes a display 80 suitable for displaying event indicia in a digital format. In the preferred embodiment, the display can include a lightweight body 81 and screen 82 that is constructed from a graphene enhanced LCD, or a pure graphene display having an integrated metal grid and transparent substrate. As will be known to those of skill in the art, graphene is a substance composed of pure carbon, with atoms arranged in a regular hexagonal pattern similar to graphite, but in a one-atom thick sheet. Such a feature can function to provide digital displays which are paper thin, flexible and incredibly lightweight. Of course, any number of other conventional screens can also be utilized herein, such as LCD and LED, for example. In either case, the display 80 can be secured to virtually any portion of the main body 11, using adhesive material such as glue or double sided tape for example.

The display 80 can be operated by a controller 90 which can function to receive user instructions, digital event indicia such as moving pictures, sound, video and pictures, for example, and instruct the screen 82 to display the same.

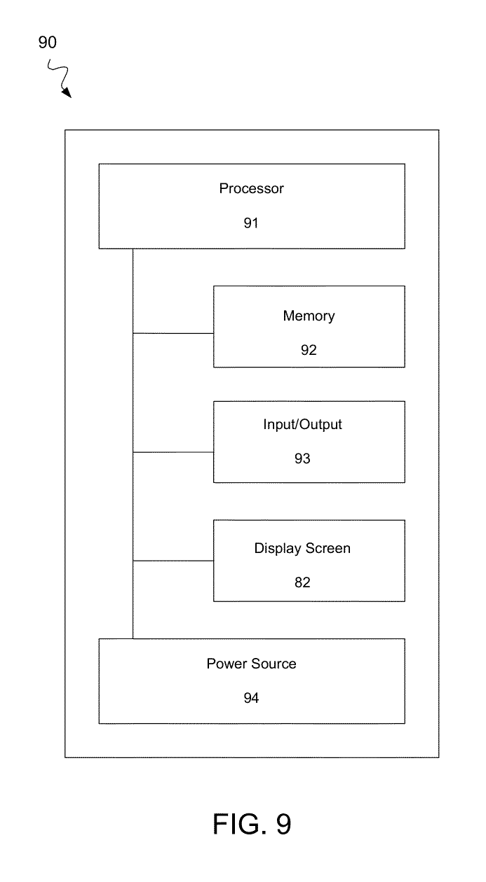

FIG. 9 illustrates one embodiment of a suitable controller 90 for use herein, that includes: a processor 91, memory 92, at least one input/output device 93 and a power source 94. In the preferred embodiment, elements 91-93 can preferably include solid state electronics disposed onto a printed circuit board that is integrated into the body of the display. Of course, any number of other known components and manufacturing methodologies can also be incorporated herein.

The processor 91 can act to execute program code stored in the memory 92 in order to allow the screen 82 to display the digital event indicia. Processors are extremely well known in the art, therefore no further description will be provided.

The memory 92 can act to store operating instructions in the form of program code for the processor 91 to execute. Although illustrated in FIG. 9 as a single component, memory 92 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 92 can also include one or more cache memories that provide temporary storage of at least some program code in order to reduce the number of times program code must be retrieved from the bulk storage device during execution. Each of these devices are well known in the art.

The one or more input/output devices 93 can include any number of known devices capable of providing two way communications with one or more of the controller elements. For example, one input/output device can include a push button disposed along the screen body that is capable of switching the screen 80 between an “on” and “off” state. Another input/output device can include a port, such as a universal serial port (USB), for example capable of receiving operating instructions for the processor and memory, and receiving the digital event indicia for display on the screen 82. The port can also function to charge to the power source, for example, when the same is integrated into the screen body.

Although not illustrated, several additional and/or optional components such as a speaker, wireless receiver and the like can also be included to further enhance the functionality and usefulness of the display 80. For example, the inclusion of a wireless receiver can allow the display 40 of the apparatus 10 to receive digital event indicia which can be transmitted thereto by a digital device of an end user, such as a cellular telephone, for example.

The power source 94 can include one or more DC batteries, preferably lightweight lithium-ion batteries that are capable of providing the necessary power requirements to display and controller.

Accordingly, the inventive concepts disclosed herein function to allow a virtually unlimited number of articles to be initially produced in a blank state (i.e., without indicia), and shipped in bulk to venues across the globe. Upon purchase by a consumer, each unit can be imprinted and/or uploaded with event specific indicia at the event. Accordingly, the above noted article and method alleviates the previous concern relating to overstocking expired merchandise, and is much more environmentally friendly as the waste associated with such expired merchandise is eliminated.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A customizable attachable article with integrated binocular pocket, said article comprising:
a singular main body material having a front surface and back surface;
an adhesive material and removable covering layer disposed along the entirety of the back surface, said material functioning to adhere to an article of clothing in a peel and stick manner without causing damage to the same; and
a pocket disposed along the front surface of the main body,
wherein each of the main body and the pocket are constructed from a single piece of waterproof static resistant paper that is compatible with a commercially available printer.

2. The article of claim 1, wherein the pocket is secured onto the main body in a generally flat manner, and further comprises a plurality of folds configured to expand a size of the pocket.

3. The article of claim 1, wherein each of the main body and the pocket are formed from a single sheet of soft polyester paper.

4. The article of claim 1, wherein each of the main body and the pocket are formed from a single sheet of 8.5×11 inch printer ready synthetic polyester paper.

5. The article of claim 1, further comprising:
a plurality of scored lines disposed along the main body forming at least one removable section.

6. The article of claim 5, wherein at least one of the removable sections includes a shape and dimension that is complementary to a shape and dimension of a front panel of a folding binocular device.

7. The article of claim 6, wherein each of the main body, pocket and at least one removable section includes identical event indicia.

8. The article of claim 6, wherein each of the main body, pocket and at least one removable section includes different event indicia.

9. The article of claim 1, further comprising:
a display screen that is removably secured to the main body, said screen including an integrated controller and functioning to display a digital event indicia.

10. A kit comprising:
a customizable attachable article with integrated binocular pocket that includes
a singular main body material having a front surface and back surface,
an adhesive material and removable covering layer disposed along the entirety of the back surface, said material functioning to adhere to an article of clothing in a peel and stick manner without causing damage to the same, and
a pocket disposed along the front surface of the main body; and
a folding binocular device having a front plate and a pair of objective lenses disposed therein,
wherein said pocket includes a dimension suitable for receiving the binoculars in a folded orientation, and each of the main body and the pocket are constructed from a single piece of waterproof static resistant paper that is compatible with a commercially available printer.

11. The kit of claim 10, further comprising:
a plurality of scored lines disposed along the main body of the article, said lines forming at least one removable section.

12. The kit of claim 11, wherein one of the removable sections includes a shape and dimension that is complementary to the shape and dimension of the front panel of the folding binocular device.

13. The kit of claim 12, wherein the removable section having the shape and dimension of the folding binocular further includes a pair of circular scored lines defining a pair of apertures.

14. The kit of claim 13, wherein said apertures include a size and shape that are complementary to the objective lenses disposed along the front panel of the binocular device.

15. The kit of claim 10, wherein each of the main body, pocket and at least one removable section includes identical event indicia.

16. The kit of claim 10, wherein each of the main body, pocket and at least one removable section includes different event indicia.

17. The kit of claim 10, wherein the article is constructed from a single sheet of 8.5×11 inch printer ready synthetic paper.

18. The kit of claim 10, further comprising:
a display screen that is configured to be secured to the main body in a removable manner, said screen including an integrated controller and functioning to display a digital event indicia.

19. A method of preparing a kit.
providing a kit that includes
a customizable attachable article with integrated binocular pocket having a singular main body material,
an adhesive material and removable covering layer disposed along an entirety of a back surface, said material functioning to adhere to an article of clothing in a peel and stick manner without causing damage to the same,
a pocket disposed along the front surface of the main body,
a folding binocular device having a front plate and a pair of objective lenses disposed therein, and
a removable section disposed within the main body, said section having a shape and dimension that is complementary to the shape and dimension of the folding binocular device;
printing, via a printer, event indicia onto the article;
separating the removable section from the main body;
adhering the removable section to the front plate of the binocular device; and
storing the binocular device within the pocket of the article.

20. The method of claim 19, further comprising:
providing a display screen having an integrated controller;
securing the display screen to the main body; and
displaying a digital event indicia.
